(19) United States
(12) Patent Application Publication
(10) Pub. No.: US 2016/0000134 A1
(43) Pub. Date: Jan. 7, 2016

(54) COMPOSITION FOR IMPROVING FLAVOR OF AND INHIBITING GROWTH OF PATHOGENIC BACTERIA IN MEAT AND POULTRY

(71) Applicant: Gum Products International Inc., Newmarket (CA)

(72) Inventors: Sandra Sandra, Keswick (CA); Arvin Lara, Keswick (CA); Bruce Manion, Churchill (CA); Adelfa Lopez, Newmarket (CA); Delfin Lopez, Newmarket (CA); Henry Liu, Richmond Hill (CA)

(21) Appl. No.: 14/323,297

(22) Filed: Jul. 3, 2014

(51) Int. Cl. A23L 3/3463; A23L 1/223; A23L 1/221; A23L 1/314; A23L 1/23

(52) U.S. Cl. CPC A23L 3/34635; A23L 1/314; A23L 1/23; A23L 1/2212; A23L 1/223; A23V 2002/00

(57) ABSTRACT

An antimicrobial composition, a process of making the composition, and a method of using the composition for attaining a longer shelf life and an improved flavor profile for food products such as meant and poultry. The antimicrobial composition comprises buffered vinegar, rosemary extract, and garlic extract.

### FIELD OF THE INVENTION

The present invention relates to compositions and method for enhancing the flavor of and inhibiting growth of pathogenic bacteria in meat and poultry.

### BACKGROUND OF THE INVENTION

Food preservation is a major challenge for food industry and associated retail outlets to insure consumer safety. Besides food discoloration and loss of flavor, shelf life associated with microbial spoilage is a serious issue. Approaches to food preservation are generally designed to enhance the shelf life of packaged products. Process improvements such as carcass washing and carefully controlled low temperature processing are now routine in the industry. Modified atmosphere packaging (MAP) has also improved microbial shelf life of fresh meat products. Some processors have begun treating meat with ionizing radiation to extend the microbial shelf life of meat products. The irradiation process is an effective method for controlling microorganisms on meat, but many consumers are wary of its use. Synthetic chemicals are also widely used to retard the growth of pathogenic bacteria. Antimicrobials chemicals listed in FSIS Directive 7120.1 and approved as ingredients of food preservatives include acidified sodium chlorite, chlorine dioxide, lauramide arginine ethyl ester, sodium hypochlorite, sodium metasilicate, and trisodium phosphate. However, many of these chemicals are not consumer-friendly and can impart off-flavor for food products.

A recent trend in the food industry is the removal of ingredients that may not be considered consumer-friendly and substituting the ingredients that can be considered natural. Natural ingredients including plant extracts have been investigated for their antimicrobial activities in food preservation. In particular, plant extracts are often used in conjunction with irradiation.

Todd describes a method for treating meat and meat products with a rosemary extract prior to irradiation to prevent or reduce lipid peroxidation and oxidation in the meat products (Todd, U.S. Pat. No. 6,099,879). Todd also describes the use of the active anti-oxidant ingredients of rosemary, i.e. carnosic acid, carnosol, and rosmarinic acid, as a replacement for rosemary extract in conjunction with irradiation. Mahrour et al. describe the use of thyme and rosemary with lower doses of irradiation (as low as 3 kGy) and the ability of these compounds to decrease fatty acid oxidation and the survival of Salmonella bacteria in irradiated chicken [Mahrour et al., Radiat. Phys. Chem., 52:77-80 (1998); Mahrour et al., Radiat. Phys. Chem., 52:81-84 (1998)]. Lacroix describes a composition comprising rosemary in irradiation for food preservation [Lacroix, U.S. 2005/0118310]. Despite all these developments, radiation-induced effects on the quality of food, i.e. undesirable changes to the organoleptic qualities, are major drawback inherent in the use of irradiation as a food preservation technique. Ideally, food processors would like to have an “all natural” claim on the product label.

Malt vinegar, also known as spirit vinegar, is prepared by neutralizing vinegar with baking soda and exhibits antimicrobial activities for gram positive bacteria such as listeria. However, it is not effective against gram negative bacteria such as salmonella, which bears a difficult-to-penetrate third wall. Mixtures of lemon juice and vinegar are reported to feature water binding and antimicrobial effects [Toledo, U.S. Pat. No. 8,182,858]. The desired pH from the mixtures ranges from 5.8 to about 6.2. Corbin discloses a composition for use with a food product comprising vinegar without describing specific range of pH [Corbin, U.S. 2010/0316780]. Rosemary and garlic are listed as optional antimicrobial agents along with many other ingredients. Berdahl, et al. describe the use of hop extracts in combination with Labiatae herb extracts, including rosemary extract for enhancing the color shelf life and retard the growth of microorganisms in meat, fish and poultry stored in an atmosphere that contains 20% or more oxygen [Berdahl, et al., U.S. Pat. No. 7,550,162]. The presence of oxygen is critical to the effectiveness of the extracts.

A need remains, therefore, for economical and effective methods of food preservation that not only provide safety but also improve the flavor profile of the food product. A particular challenge for inhibiting both gram positive bacteria and gram negative bacteria is the application of natural ingredients with minimal mechanical intervention such as irradiation and modified atmosphere packaging.

### SUMMARY OF THE INVENTION

The present invention provides an antimicrobial composition for treating a food product to attain a longer shelf life and an improved flavor profile, a process of making the composition, and a method of using the composition as a natural food preservative. In one aspect of the invention, the composition comprises buffered vinegar, rosemary extract, and garlic extract, all of which are label-friendly and food-approved ingredients, thus eliminating the need to seek regulatory approvals.

In another aspect of the invention there is provided a method of treating a food product to attain a longer shelf and an improved flavor profile comprising applying to the food product an antimicrobial composition comprising buffered vinegar, rosemary extract, and garlic extract. The composition can be used as a direct-addition food ingredient in for ready-to-eat food product, as a marinade for ready-to-cook food product, or as a food safety wash raw meat and poultry carcasses or cuts. The application of this composition to the food product can surprisingly extend shelf life of the food product as well as inhibit the growth of both gram positive and gram negative pathogenic bacteria, including but not limited to Listeria monocytogenes, Clostridium botulinum, Escherichia coli (O157:H7 and others), Salmonella spp., and Staphylococcus aureus.

In a further aspect of the invention there is provided a treated food product comprising buffered vinegar, rosemary extract, and garlic extract, wherein the treated food product exhibits a longer shelf life and an improved flavor profile.

In yet another aspect of the invention there is provided a method of preparing a composition for treating a food product, comprising mixing buffered vinegar, rosemary extract, and garlic extract, wherein the buffered vinegar is between about 80% to 98% by weight, the rosemary extract is between about 0.1% to 10% by weight, and the garlic extract is between about 0.1% to 10% by weight.

### BRIEF DESCRIPTION OF THE FIGURES

FIG. 1A illustrates the antimicrobial effect of an exemplary composition (GPI AMX3) of the present invention. The growth of all three tested bacteria (Listeria monocytogenes, Escherichia coli (O157:H7), and Salmonella enterica) were inhibited over a 24 hour span.

FIG. 2A illustrates the surviving bacterial population in an untreated-control. Significant growth was observed for all three bacteria (Listeria monocytogenes, Escherichia coli (O157:H7), and Salmonella enterica) in the untreated-control.

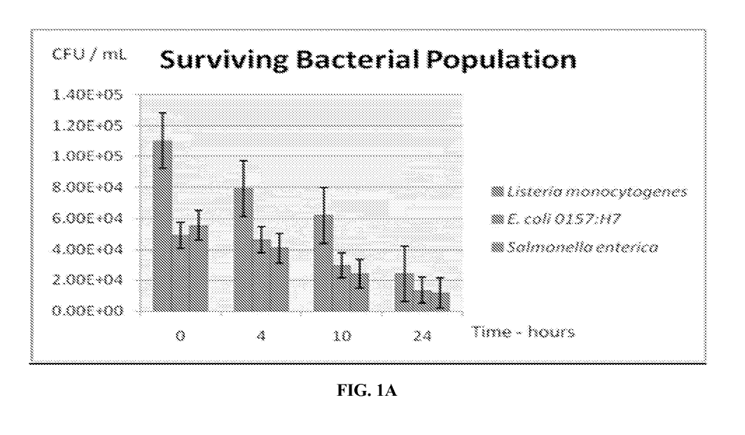

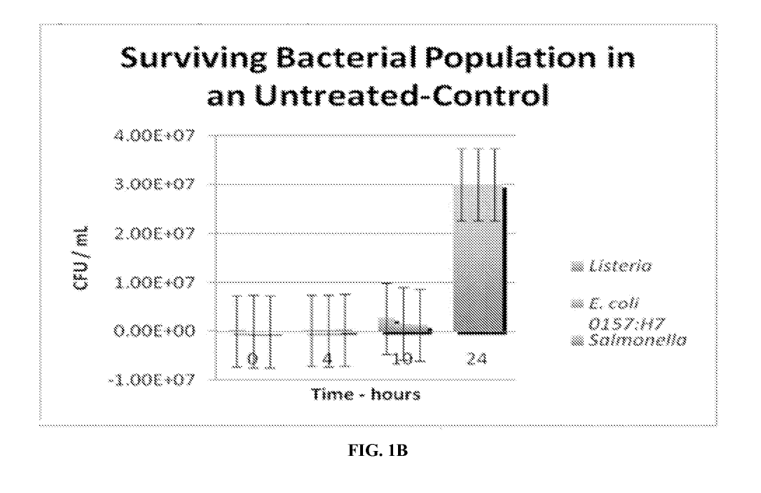

FIG. 1B illustrates the effect of an reference composition (GPI AMX5) on the growth of Listeria monocytogenes, Escherichia coli (O157:H7), and Salmonella enterica.

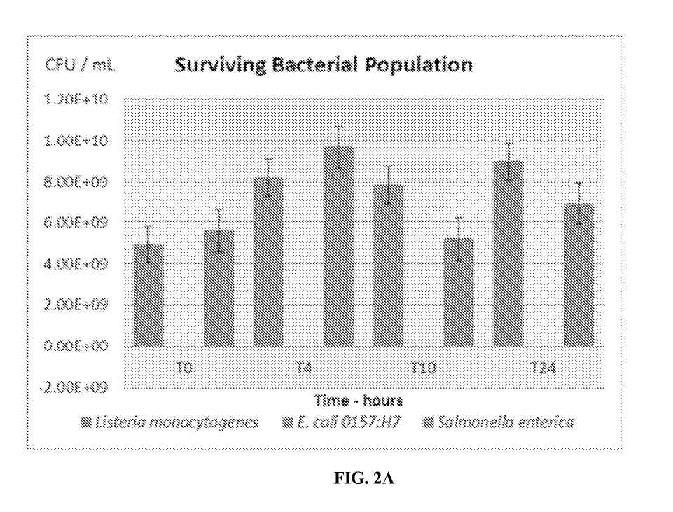

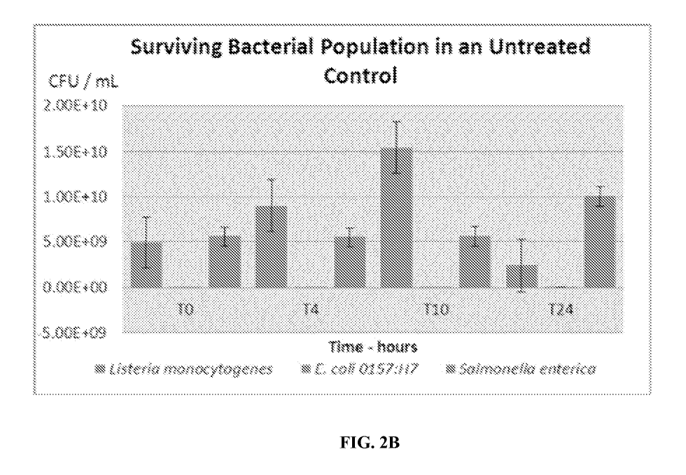

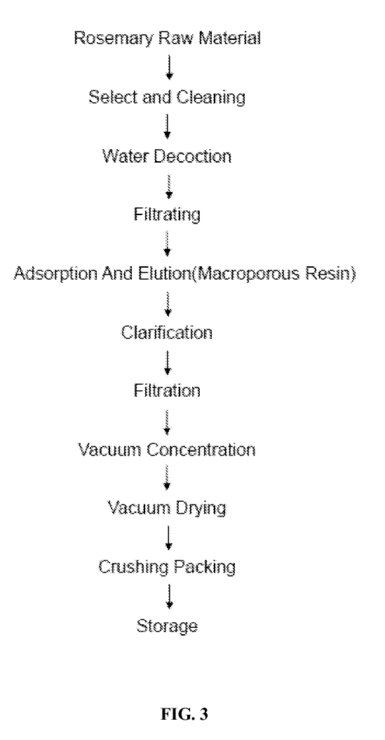

FIG. 2B illustrates the growth of Listeria monocytogenes, Escherichia coli (O157:H7), and Salmonella enterica in an untreated-control in comparison to the result shown in FIG. 1B.

FIG. 3 illustrates an exemplary process flow chart of rosemary extract.

### DETAILED DESCRIPTION OF THE INVENTION

The present invention provides compositions comprising ingredients derived from natural sources that exhibit excellent antimicrobial effects such that the safety, shelf life and flavor profile of food products are substantially improved. The present invention also provides a method of food preservation that results in safe, high quality food, which is more economical than current methods using radiation. The composition of the present invention can be used as a direct-addition food ingredient in ready-to-eat food product, a marinade for ready-to-cook food product, or a food safety wash for raw meat and poultry carcasses or cuts. The composition can also be used in combination with food safety hurdles.

### DEFINITIONS

The term “food product” as used herein refers generally to any suitable form of food, including meats, poultry, seafood, and/or any other suitable product. Meats may include beef parts, pork, lamb, wild game, or any other suitable form. Poultry may include any form of bird kept, harvested, or domesticated for meat and/or eggs. Seafood may include any fish, shellfish, or any other form of food that is caught or harvested in water, including fresh water and salt water. The food product may be in the form of ready-to-eat food, ready-to-cook food, or raw food. Raw food includes, but is not limited to meat and poultry carcasses, cut portions thereof, and ground portions thereof.

The term “flavor profile” as used herein refers to organoleptic properties of food products, including taste, smell, texture and appearance. Sensory evaluation can be conducted to confirm the effect of the composition of the present invention on the flavor profile of the food product. Methods of sensory evaluation of food products are well known in the art [Larmond, Laboratory methods for Sensory Evaluation of Foods, Research branch of Agriculture Canada (1977)].

The term “food preservation” as used herein refers to methods which maintain or enhance food safety, for example, by controlling the growth and proliferation of pathogenic and spoilage micro-organisms, thus guarding against food poisoning and delaying or preventing food spoilage. Food preservation helps food remain safe for consumption for longer periods of time (i.e. improves the shelf life) and inhibits or prevents nutrient deterioration and/or organoleptic changes which cause food to become less palatable.

The term “pathogenic bacteria” as used herein refers to both gram positive and gram negative bacteria that are capable of causing disease or illness in an animal or a human, for example, by the production of endotoxins, or by the presence of a threshold level of micro-organisms so as to cause food poisoning, or other undesirable physiological reactions in humans or animals. Non-limiting examples of pathogenic bacteria include Listeria monocytogenes, Clostridium botulinum, Escherichia coli (O157:H7 and others), Salmonella spp., and Staphylococcus aureus.

The term “shelf life” as used herein refers to the period of time that a food product remains saleable to retail customers. For example, in traditional meat processing, the shelf life of fresh meat and meat by-products is about 30 to 40 days after an animal has been slaughtered. Refrigeration of meat during this period of time largely arrests and/or retards the growth of micro-organisms including pathogenic bacteria. After about 30 to 40 days, however, refrigeration can no longer effectively control the proliferation of micro-organisms. Micro-organisms present on meat products after this time period may have proliferated to a great extent and/or have generated unacceptable levels of undesirable by-products. Spoilage micro-organisms may also act to discolor meat, making such meat unappealing and undesirable for human consumption. Pathogenic bacteria may have proliferated in this time period to a level wherein they are capable of causing disease in an animal that consumes the food product.

The term “treating” as used herein refers to means of processing a food product, including, for example, applying or adding the composition of the present invention to a ready-to-eat food product, marinating a ready-to-cook food product with the composition, and washing raw meat and poultry carcasses or cuts with the composition. Applying the composition to food products includes, but is not limited to, injection, vacuum tumbling, spraying, painting or dipping.

The term “vinegar” by itself as used herein refers to un-buffered vinegar which can be prepared by any known process or provided from any source.

### Vinegar and Buffered Vinegar

Vinegar can be prepared by any known process or provided from any source. Representative strains of acetic acid bacteria includes, for example, Acetobacter aceti and Gluconobacter suboxydans [Saeki et al., Development of thermotolerant acetic acid bacteria useful for vinegar fermentation at higher temperatures, Biosci. Biotech. Biochem., 61 (1), 138-145, 1997]. In some embodiments of the present invention, vinegar obtained from the natural fermentation of Acetobacter aceti is used to prepare buffered vinegar. In some embodiments of the present invention, vinegar is obtained from commercial source.

Production and composition of vinegar are readily available in the literature, including for example Martin R Adams, VINEGAR, Encyclopedia of Food Microbiology, 1999, 2258-2263, and Bulletin of the International Diary Federation 455/2012, the entire disclosures of which are herein incorporated by reference.

A buffered vinegar can be prepared by mixing a vinegar with sodium carbonate, sodium bicarbonate, potassium carbonate, potassium bicarbonate, any known agents for buffering, or by any known process for preparing a buffered solution. Sodium carbonate, sodium bicarbonate, potassium carbonate, potassium bicarbonate, and other known agents for preparing the buffered vinegar can be used alone or in combination. In some embodiments of the present invention, the preparation of the buffered vinegar does not involve heating or evaporation. In some embodiments, the resulting buffered vinegar is further condensed.

The pH of the resulting buffered vinegar is determined by the Henderson-Hasselbach equation as follows: pH=pKa+log ([sodium acetate/acetic acid). In some embodiments, the pH of the resulting buffered vinegar is between about 4.0 to 6.5. In some embodiments, the pH of the resulting buffered vinegar is between about 4.0 to 4.8. In some embodiments, the pH of the resulting buffered vinegar is between about 4.0 to 4.6. In some embodiments, the pH of the resulting buffered vinegar is between about 4.0 to 4.4. In some embodiments, the pH of the resulting buffered vinegar is between about 4.0 to 4.2. In some embodiments, the pH of the resulting buffered vinegar is between about 4.4 to 5.2. In some embodiments, the pH of the resulting buffered vinegar is between about 4.4 to 5.0. In some embodiments, the pH of the resulting buffered vinegar is between about 4.4 to 4.8. In some embodiments, the pH of the resulting buffered vinegar is between about 4.4 to 4.6. In some embodiments, the pH of the resulting buffered vinegar is between about 4.5 to 6.5. In some embodiments, the pH of the resulting buffered vinegar is between about 4.5 to 6.0. In some embodiments, the pH of the resulting buffered vinegar is between about 4.8 to 5.6. In some embodiments, the pH of the resulting buffered vinegar is between about 4.8 to 5.4. In some embodiments, the pH of the resulting buffered vinegar is between about 4.8 to 5.2. In some embodiments, the pH of the resulting buffered vinegar is between about 4.8 to 5.0. In some embodiments, the pH of the resulting buffered vinegar is between about 4.9 to 6.0. In some embodiments, the pH of the resulting buffered vinegar is between about 4.9 to 5.7. In some embodiments, the pH of the resulting buffered vinegar is between about 5.0 to 5.6. In some embodiments, the pH of the resulting buffered vinegar is between about 5.1 to 5.5.

Procedures for adjusting the pH of a buffered vinegar is not limited to what is disclosed in the present invention and are readily available in the literature without undue experiments.

### Rosemary Extract and Garlic Extract

Rosemary extract and garlic extract can be prepared utilizing methods well known in the art. Rosemary extracts can be prepared by extracting rosemary with food grade solvents or with supercritical carbon dioxide. Extracts consisting largely of lipophillic components contain carnosic acid and carnosol and other phenolic constituents. The amount of carnosic acid in the extract can range from 0.5 to 50% or more. Carnosol contents can range from 0.1 to 10% or more. Extracts consisting largely of hydrophillic substances contain rosmarinic acid. Rosmarinic acid content can range from 0.1 to 35% or more, however, these concentrations in the extract are not considered limiting. Extracts made using solvents of intermediate polarity contain both the lipophilic and hydrophilic components. In some embodiments, the rosemary extracts are used as prepared. In some embodiments, the rosemary extracts are further purified to contain one or more components including carnosic acid, carnosol, and rosmarinic acid.

In some embodiments, the rosemary extract contains a minimum level of about 7.5% rosmarinic acid. In some embodiments, the rosemary extract contains a minimum level of about 5% rosmarinic acid. In some embodiments, the rosemary extract contains a minimum level of about 2.5% rosmarinic acid. In some embodiments, the rosemary extract contains a minimum level of about 1% rosmarinic acid. In some embodiments, the rosemary extract contains a minimum level of about 0.5% rosmarinic acid. In some embodiments, the rosemary extract contains a minimum level of about 0.2% rosmarinic acid. In some embodiments, the rosemary extract contains a minimum level of about 0.1% rosmarinic acid.

In some embodiments, the garlic extract contains a minimum level of about 5% allicin. In some embodiments, the garlic extract contains a minimum level of about 2.5% allicin. In some embodiments, the garlic extract contains a minimum level of about 1.5% allicin. In some embodiments, the garlic extract contains a minimum level of about 1% allicin. In some embodiments, the garlic extract contains a minimum level of about 0.5% allicin. In some embodiments, the garlic extract contains a minimum level of about 0.2% allicin. In some embodiments, the garlic extract contains a minimum level of about 0.1% allicin.

Rosemary extract has been the focus of a number of studies for its antiradical activities. An in-depth analysis of rosemary extract is reported by Luis, et al., Spanish Journal of Agricultural Research, 2005, 3(1), 106-112, the entire disclosure of which is incorporated herein by reference.

The production procedures for rosemary extract and garlic extract are generally known to one of ordinary skill in the art without undue experiments. A non-limiting exemplary process flow chart is shown in FIG. 3.

### Composition of the Present Invention

The composition of the present invention comprises buffered vinegar, rosemary extract, and garlic extract, which are prepared as described above. Besides its anti-bacteria activities, the composition also impart on the food product other desirable effects including enhanced flavor, anti-oxidant properties, tenderisation.

In some embodiments of the present invention, the composition comprises between about 80-98.8% of buffered vinegar by weight. In some embodiments of the present invention, the composition comprises about 98% of buffered vinegar by weight. In some embodiments of the present invention, the composition comprises about 95% of buffered vinegar by weight. In some embodiments of the present invention, the composition comprises about 90% of buffered vinegar by weight. In some embodiments of the present invention, the composition comprises about 85% of buffered vinegar by weight. In some embodiments of the present invention, the composition comprises about 80% of buffered vinegar by weight.

In some embodiments of the present invention, the composition comprises between about 0.1 to 10% of rosemary extract by weight. In some embodiments of the present invention, the composition comprises about 10% of rosemary extract by weight. In some embodiments of the present invention, the composition comprises about 8% of rosemary extract by weight. In some embodiments of the present invention, the composition comprises about 5% of rosemary extract by weight. In some embodiments of the present invention, the composition comprises about 3% of rosemary extract by weight. In some embodiments of the present invention, the composition comprises about 1% of rosemary extract by weight. In some embodiments of the present invention, the composition comprises about 0.5% of rosemary extract by weight. In some embodiments of the present invention, the composition comprises about 0.3% of rosemary extract by weight. In some embodiments of the present invention, the composition comprises about 0.1% of rosemary extract by weight.

In some embodiments of the present invention, the composition comprises between about 0.1 to 10% of garlic extract by weight. In some embodiments of the present invention, the composition comprises about 10% of garlic extract by weight. In some embodiments of the present invention, the composition comprises about 8% of garlic extract by weight. In some embodiments of the present invention, the composition comprises about 5% of garlic extract by weight. In some embodiments of the present invention, the composition comprises about 3% of garlic extract by weight. In some embodiments of the present invention, the composition comprises about 1% of garlic extract by weight. In some embodiments of the present invention, the composition comprises about 0.5% of garlic extract by weight. In some embodiments of the present invention, the composition comprises about 0.3% of garlic extract by weight. In some embodiments of the present invention, the composition comprises about 0.1% of garlic extract by weight. In some embodiments, the composition does not contain any other ingredient besides buffered vinegar, rosemary extract, and garlic extract. In general, certain embodiments comprise 80-99.8% by wt. buffered vinegar, 0.1-10% by wt. rosemary extract, and 0.1-10% by wt. garlic extract.

Non-limiting exemplary embodiments of the composition of the present invention include the following:

about 80% of buffered vinegar, about 10% of rosemary extract, and about 10% of garlic extract;

about 85% of buffered vinegar, about 10% of rosemary extract, and about 5% of garlic extract;

about 85% of buffered vinegar, about 5% of rosemary extract, and about 10% of garlic extract;

about 90% of buffered vinegar, about 9.9% of rosemary extract, and about 0.1% of garlic extract;

about 90% of buffered vinegar, about 9.5% of rosemary extract, and about 0.5% of garlic extract;

about 90% of buffered vinegar, about 9% of rosemary extract, and about 1% of garlic extract;

about 90% of buffered vinegar, about 8.5% of rosemary extract, and about 1.5% of garlic extract;

about 90% of buffered vinegar, about 8% of rosemary extract, and about 2% of garlic extract;

about 90% of buffered vinegar, about 7.5% of rosemary extract, and about 2.5% of garlic extract;

about 90% of buffered vinegar, about 7% of rosemary extract, and about 3% of garlic extract;

about 90% of buffered vinegar, about 6.5% of rosemary extract, and about 3.5% of garlic extract;

about 90% of buffered vinegar, about 6% of rosemary extract, and about 4% of garlic extract;

about 90% of buffered vinegar, about 5.5% of rosemary extract, and about 4.5% of garlic extract;

about 90% of buffered vinegar, about 5% of rosemary extract, and about 5% of garlic extract;

about 90% of buffered vinegar, about 4.5% of rosemary extract, and about 5.5% of garlic extract;

about 90% of buffered vinegar, about 4% of rosemary extract, and about 6% of garlic extract;

about 90% of buffered vinegar, about 3.5% of rosemary extract, and about 6.5% of garlic extract;

about 90% of buffered vinegar, about 3% of rosemary extract, and about 7% of garlic extract;

about 90% of buffered vinegar, about 2.5% of rosemary extract, and about 7.5% of garlic extract;

about 90% of buffered vinegar, about 2% of rosemary extract, and about 8% of garlic extract;

about 90% of buffered vinegar, about 1.5% of rosemary extract, and about 8.5% of garlic extract;

about 90% of buffered vinegar, about 1% of rosemary extract, and about 9% of garlic extract;

about 90% of buffered vinegar, about 0.5% of rosemary extract, and about 9.5% of garlic extract;

about 90% of buffered vinegar, about 0.1% of rosemary extract, and about 9.9% of garlic extract;

about 95% of buffered vinegar, about 4.9% of rosemary extract, and about 0.1% of garlic extract; about 95% of buffered vinegar, about 4.5% of rosemary extract, and about 0.5% of garlic extract;

about 95% of buffered vinegar, about 4.0% of rosemary extract, and about 1% of garlic extract;

about 95% of buffered vinegar, about 3.5% of rosemary extract, and about 1.5% of garlic extract;

about 95% of buffered vinegar, about 3.0% of rosemary extract, and about 2.0% of garlic extract;

about 95% of buffered vinegar, about 2.5% of rosemary extract, and about 2.5% of garlic extract;

about 95% of buffered vinegar, about 2.0% of rosemary extract, and about 3.0% of garlic extract;

about 95% of buffered vinegar, about 1.5% of rosemary extract, and about 3.5% of garlic extract;

about 95% of buffered vinegar, about 1.0% of rosemary extract, and about 4.0% of garlic extract;

about 95% of buffered vinegar, about 0.5% of rosemary extract, and about 4.5% of garlic extract;

about 95% of buffered vinegar, about 0.2% of rosemary extract, and about 4.8% of garlic extract;

about 95% of buffered vinegar, about 0.1% of rosemary extract, and about 4.9% of garlic extract;

about 96% of buffered vinegar, about 0.1% of rosemary extract, and about 3.9% of garlic extract;

about 96% of buffered vinegar, about 0.5% of rosemary extract, and about 3.5% of garlic extract;

about 96% of buffered vinegar, about 1.0% of rosemary extract, and about 3.0% of garlic extract;

about 96% of buffered vinegar, about 1.5% of rosemary extract, and about 2.5% of garlic extract;

about 96% of buffered vinegar, about 2.0% of rosemary extract, and about 2.0% of garlic extract;

about 96% of buffered vinegar, about 2.5% of rosemary extract, and about 1.5% of garlic extract;

about 96% of buffered vinegar, about 3.0% of rosemary extract, and about 1.0% of garlic extract;

about 96% of buffered vinegar, about 3.5% of rosemary extract, and about 0.5% of garlic extract;

about 96% of buffered vinegar, about 3.9% of rosemary extract, and about 0.1% of garlic extract;

about 97% of buffered vinegar, about 0.1% of rosemary extract, and about 2.9% of garlic extract;

about 97% of buffered vinegar, about 0.5% of rosemary extract, and about 2.5% of garlic extract;

about 97% of buffered vinegar, about 1.0% of rosemary extract, and about 2.0% of garlic extract;

about 97% of buffered vinegar, about 1.5% of rosemary extract, and about 1.5% of garlic extract;

about 97% of buffered vinegar, about 2.0% of rosemary extract, and about 1.0% of garlic extract;

about 97% of buffered vinegar, about 2.5% of rosemary extract, and about 0.5% of garlic extract;

about 97% of buffered vinegar, about 2.9% of rosemary extract, and about 0.1% of garlic extract;

about 98% of buffered vinegar, about 0.1% of rosemary extract, and about 1.9% of garlic extract;

about 98% of buffered vinegar, about 0.5% of rosemary extract, and about 1.5% of garlic extract;

about 98% of buffered vinegar, about 1.0% of rosemary extract, and about 1.0% of garlic extract;

about 98% of buffered vinegar, about 1.5% of rosemary extract, and about 0.5% of garlic extract;

about 98% of buffered vinegar, about 1.9% of rosemary extract, and about 0.1% of garlic extract;

about 99% of buffered vinegar, about 0.9% of rosemary extract, and about 0.1% of garlic extract;

about 99% of buffered vinegar, about 0.8% of rosemary extract, and about 0.2% of garlic extract;

about 99% of buffered vinegar, about 0.7% of rosemary extract, and about 0.3% of garlic extract;

about 99% of buffered vinegar, about 0.6% of rosemary extract, and about 0.4% of garlic extract;

about 99% of buffered vinegar, about 0.5% of rosemary extract, and about 0.5% of garlic extract;

about 99% of buffered vinegar, about 0.4% of rosemary extract, and about 0.6% of garlic extract;

about 99% of buffered vinegar, about 0.3% of rosemary extract, and about 0.7% of garlic extract;

about 99% of buffered vinegar, about 0.2% of rosemary extract, and about 0.8% of garlic extract;

about 99% of buffered vinegar, about 0.1% of rosemary extract, and about 0.9% of garlic extract;

about 99.5% of buffered vinegar, about 0.4% of rosemary extract, and about 0.1% of garlic extract;

about 99.5% of buffered vinegar, about 0.3% of rosemary extract, and about 0.2% of garlic extract;

about 99.5% of buffered vinegar, about 0.2% of rosemary extract, and about 0.3% of garlic extract;

about 99.5% of buffered vinegar, about 0.1% of rosemary extract, and about 0.4% of garlic extract; and

about 99.8% of buffered vinegar, about 0.1% of rosemary extract, and about 0.1% of garlic extract.

In a related aspect of the invention there is provided a method of preparing a composition for treating a food product, comprising mixing buffered vinegar, rosemary extract, and garlic extract, wherein the buffered vinegar is between about 80% to 98% by weight and has a pH of between, the rosemary extract is between about 0.1% to 10% by weight, and the garlic extract is between about 0.1% to 10% by weight. The buffered vinegar, rosemary extract, and garlic extract can be mixed in any sequence known to one skilled in the art without undue experiments.

### Applying the Compositions to Food Products

In one aspect of the invention there is provided a method of treating a food product to attain a longer shelf and an improved flavor profile comprising applying to the food product an antimicrobial composition comprising buffered vinegar, rosemary extract, and garlic extract. The composition can be used as a direct-addition food ingredient in ready-to-eat food product, as a marinade for ready-to-cook food product, or as a food safety wash raw meat and poultry carcasses or cuts. The application of this composition to the food product can extend shelf-life as well as control the growth of both gram positive and gram negative pathogenic bacteria, including but not limited to Listeria monocytogenes, Clostridium botulinum, Escherichia coli (O157:H7 and others), Salmonella spp., and Staphylococcus aureus.

The composition of the present invention is applied to the food product in a ratio of between about 0.001% and 10.0%. In some embodiments of the present invention, the composition is applied to the food product in a ratio of between about 0.005% and 5.0%. In some embodiments, the composition is applied to the food product in a ratio of between about 0.01% and 2.5%.

The range of ratios when applying the composition of the present invention to the food product depends on factors including the type of the food product, the intended sensory effect, the extended shelf life, the level of pathogen reduction or inhibition as well as protection against post-treatment contamination, and can be readily determined by one of ordinary skill in the art without undue experiments. For example, when the composition of the present invention is used as an ingredient, the ratio can be up to 3%. When used as a wash, the composition can be used at 100% strength. Other factors such as the type of muscle, the size of the muscle (whole, chunked, ground), contact time, and the method of application (marinade through passive diffusion or active absorption via brine/marinade injectors/vacuum tumblers, spray cabinets, washes or dips/baths) will also affect the absorption kinetics. An important factor is sensory perception of flavor by consumers. One of ordinary skill in the art can accordingly adjust the ratio using routine tests such as sensory testing without resorting to undue experiments. Methods of applying the composition to food products include, but are not limited to, injection, vacuum tumbling, spraying, painting or dipping. Alternatively, the composition can be applied to food products as a marinade, breading, seasoning rub, glaze, colorant mixture, and the like. In the case of ground or powdered food products, the compound or formulation may be mixed directly into the ground or powdered material. The important criterion to be met when applying the formulations is that the composition is available to the surface subject to microbial degradation. In some embodiments, the composition may be applied by soaking the food product in the composition for a predetermined amount of time. In some embodiments, the composition may be indirectly placed into contact with the food surface by applying the composition to food packaging and thereafter applying the packaging to the food surface.

The optimum amount of the composition to be used will depend on the nature and texture of the particular food product to be treated and the method used to apply the composition to the food product, and can be determined without undue experimentation by one skilled in the art.

The composition of the present invention can be used alone or in combination with other food safety hurdles. In some embodiments, the food product is treated with the composition of the present invention without additional agents. In some embodiments, the food product is treated with the composition of the present invention in combination with one or more other agents and/or procedures to enhance the antimicrobial effect and/or improve the flavor profile of the food product. Other agents to be used in combination with the composition of the present invention include, but are not limited to, natural ingredients such as plant extract and those listed in FSIS Directive 7120.1 and approved as ingredients of food preservatives. Non-limiting examples of such agents to include the following: acetified sodium chlorite, calcium hypochlorite, cetylpyridinium chloride, chlorine gas, chlorine dioxide, DBDMH (1,3 dibromo-5,5-dimethylhydantion), electrolytically generated hypochlorous acid, an aqueous solution of citric and hydrochloric acids adjusted to a pH of 1.0 to 2.0, a blend of citric, phosphoric, and hydrochloric acids, lactic acid bacteria mixture consisting of lactobacillus acidophilus, lactobacillus lactic, and pediococcus acidilactici, lauramide arginine ethyl ester (LAE), ozone, solution of peroxyacetic acid, octanoic acid, acetic acid, hydrogen peroxide, peroxyoctanoic acid, and hydroxyethylidene-1,1-diphosphonic acid (HEDP), solution of peroxyacetic acid, hydrogen peroxide, acetic acid, sodium hypochlorite, sodium metasilicate, and trisodium phosphate. Non-limiting examples of other procedures to be used in combination with the composition of the present invention include low temperature processing, modified atmosphere packaging, and irradiation.

The optimum amount and sequence of the additional agents and/or procedures to be used in combination with the composition of the present invention will depend on the nature and texture of the particular food product to be treated and the method used to apply the composition to the food product, and can be determined without undue experimentation by one skilled in the art.

In another aspect of the invention there is provided a treated food product comprising buffered vinegar, rosemary extract, and garlic extract, wherein the treated food product exhibits a longer shelf life and an improved flavor profile. In some embodiments of the present invention, the food product treated with the composition of the present invention does not contain additional agents. In some embodiments of the present invention, the food product treated with the composition of the present invention contain one or more additional agents.

### Testing the Composition

The present invention provides an antimicrobial composition for enhancing the shelf life and improving the flavor profile of food products. The compositions can be tested by standard techniques known to one skilled in the art to determine their antimicrobial effects. One skilled in the art will appreciate that a particular composition will not necessarily work uniformly well on all food types due, in part, to differences in the chemical constitution of various foods. The composition should, therefore, be tested on the food product(s) for which its application is ultimately intended.

As is known in the art, shelf life can be evaluated by determining the length of time a food product can be stored before the content of micro-organisms or pathogenic bacteria reaches a certain threshold. For example, the appropriate threshold for certain bacteria is when the bacterial count in the food product reaches 6 log.

Comparing with untreated food products, food products treated with the composition of the present invention have an improved flavor profile in one or more organoleptic properties, including taste, smell, texture and appearance. Sensory evaluation of food products treated with the composition of the present invention can be conducted to confirm the effect on the flavor profile of the food product. Such evaluation will also confirm that the selected concentrations for the ingredients of the composition do not themselves adversely affect the quality of the food (i.e. the taste, smell, texture and/or appearance). Methods of sensory evaluation of food products are well known in the art [Larmond, Laboratory methods for Sensory Evaluation of Foods, Research branch of Agriculture Canada (1977)]. Because the ingredient of the composition is already known in the art as a food additive, the final concentration of the ingredient included in the composition is within the range known to be safe for use in the food industry.

### EXAMPLES

To gain a better understanding of the invention described herein, the following examples are set forth. It should be understood that these examples are for illustrative purposes only. Therefore, they should not limit the scope of this invention in any way.

### Testing the Antimicrobial Effects of the Antimicrobial Composition

### Example 1

Concentrations of the antimicrobial composition (coded GPI AMX3, 96% buffered vinegar 2% rosemary extract, and 2% garlic extract) of the present invention were prepared in triplicate at 2.5% (7.5 mL of the concentrated solution+292.5 mL of diluent). Listeria monocytogenes, Escherichia coli O157:H7 and Salmonella enterica bacteria were grown separately on Tryptic Soy Agar with 5% Sheep's Blood (TSAB) for 2 days and then standardized to approximately 10,000 or 1,000,000,000 CFU/mL using spectrophotometry. In triplicate, 2 mL of the standardized culture was treated with 18 mL of 2.5% antimicrobial solution and incubated at 35° C. for 4-hour, 10-hour, and 24-hour treatments. Initial treatments and inoculated treatments were serially diluted, plated on TSAB, and incubated at 35° C. for 48-hours and microbial growth was quantified.

Percentage kill-rates for antimicrobial solution GPI AMX3 (concentrated at 2.5%), were determined for Listeria monocytogenes, Escherichia coli O157:H7 and Salmonella enterica after 4-hour, 10-hour and 24-hour treatments. Tables 1A through 3A, show that the antimicrobial solution GPI AMX3 killed 28.25%, 43.55% and 78.04% of L. monocytogenes at 4-hour, 10-hour and 24-hour treatments, respectively. Tables 4A through 6A, show that the antimicrobial solution GPI AMX3 killed 5.85%, 41.20% and 73.36% of E. coli 0157:H7 at 4-hour, 10-hour and 24-hour treatments, respectively. Tables 7A through 9A, show that the antimicrobial solution GPI AMX3 killed 24.44%, 53.44% and 78.86% of S. enterica at 4-hour, 10-hour and 24-hour treatments, respectively.

TABLE 1A
Efficacy of GPI AMX3 solution against Listeria monocytogenes
at 4-hours.

| | | Sterility | |
|---|---|---|---|
| Viability control | Positive/Negative | Control | Positive/Negative |
| 1 | + | 1 | − |
| 2 | + | 2 | − |

| Sample | CFU | Log Reduction | % Reduction |
|---|---|---|---|
| GPI AMX3 | 7.92 × 10⁴ | 0.14 | 28.25% |
| Control-initial | 1.10 × 10⁵ | | |
| population | | | |

TABLE 2A
Efficacy of GPI AMX3 solution against
Listeria monocytogenes at 10-hours.

| | Positive/ | | Positive/ |
|---|---|---|---|
| Viability control | Negative | Sterility Control | Negative |
| 1 | + | 1 | − |
| 2 | + | 2 | − |
| Sample | CFU | Log Reduction | % Reduction |
| GPI AMX3 | 6.20 × 10⁴ | 0.25 | 43.55% |
| Control-initial | 1.10 × 10⁵ | | |
| population | | | |

TABLE 3A
Efficacy of GPI AMX3 solution against
Listeria monocytogenes at 24-hours.

| | Positive/ | | Positive/ |
|---|---|---|---|
| Viability control | Negative | Sterility Control | Negative |
| 1 | + | 1 | − |
| 2 | + | 2 | − |
| Sample | CFU | Log Reduction | % Reduction |
| GPI AMX3 | 2.43 × 10⁴ | 0.66 | 78.04% |
| Control-initial | 1.10 × 10⁵ | | |
| population | | | |

TABLE 4A
Efficacy of GPI AMX3 solution against
Escherichia coli 0157:H7 at 4-hours.

| | Positive/ | | Positive/ |
|---|---|---|---|
| Viability control | Negative | Sterility Control | Negative |
| 1 | + | 1 | − |
| 2 | + | 2 | − |
| Sample | CFU | Log Reduction | % Reduction |
| GPI AMX3 | 4.65 × 10⁴ | 0.03 | 5.85% |
| Control-initial | 4.93 × 10⁴ | | |
| population | | | |

TABLE 5A
Efficacy of GPI AMX3 solution against
Escherichia coli 0157:H7 at 10-hours.

| | Positive/ | | Positive/ |
|---|---|---|---|
| Viability control | Negative | Sterility Control | Negative |
| 1 | + | 1 | − |
| 2 | + | 2 | − |
| Sample | CFU | Log Reduction | % Reduction |
| GPI AMX3 | 2.97 × 10⁴ | 0.27 | 41.20% |
| Control-initial | 4.93 × 10⁴ | | |
| population | | | |

TABLE 6A
Efficacy of GPI AMX3 solution against
Escherichia coli 0157:H7 at 24-hours.

| | Positive/ | | Positive/ |
|---|---|---|---|
| Viability control | Negative | Sterility Control | Negative |
| 1 | + | 1 | − |
| 2 | + | 2 | − |
| Sample | CFU | Log Reduction | % Reduction |
| GPI AMX3 | 1.35 × 10⁴ | 0.65 | 73.36% |
| Control-initial | 4.93 × 10⁴ | | |
| population | | | |

TABLE 7A
Efficacy of GPI AMX3 solution against
Salmonella enterica at 4-hours.

| | Positive/ | | Positive/ |
|---|---|---|---|
| Viability control | Negative | Sterility Control | Negative |
| 1 | + | 1 | − |
| 2 | + | 2 | − |
| Sample | CFU | Log Reduction | % Reduction |
| GPI AMX3 | 4.12 × 10⁴ | 0.13 | 24.44% |
| Control-initial | 5.57 × 10⁴ | | |
| population | | | |

TABLE 8A
Efficacy of GPI AMX3 solution against
Salmonella enterica at 10-hours.

| | Positive/ | | Positive/ |
|---|---|---|---|
| Viability control | Negative | Sterility Control | Negative |
| 1 | + | 1 | − |
| 2 | + | 2 | − |
| Sample | CFU | Log Reduction | % Reduction |
| GPI AMX3 | 2.43 × 10⁴ | 0.40 | 53.44% |
| Control-initial | 5.57 × 10⁴ | | |
| population | | | |

TABLE 9A
Efficacy of GPI AMX3 solution against
Salmonella enterica at 24-hours.

| | Positive/ | | Positive/ |
|---|---|---|---|
| Viability control | Negative | Sterility Control | Negative |
| 1 | + | 1 | − |
| 2 | + | 2 | − |
| Sample | CFU | Log Reduction | % Reduction |
| GPI AMX3 | 1.18 × 10⁴ | 0.68 | 78.86% |
| Control-initial | 5.57 × 10⁴ | | |
| population | | | |

TABLE 10A
Growth Data for Listeria in an Untreated Control at 4-hours.

| | Positive/ | | Positive/ |
|---|---|---|---|
| Viability control | Negative | Sterility Control | Negative |
| 1 | + | 1 | − |
| 2 | + | 2 | − |
| Sample | CFU | Log Reduction | % Reduction |
| Control-T-4 | 2.48 × 10⁵ | −0.15 | −65.79% |
| Population | | | |
| Control-initial | 1.50 × 10⁵ | | |
| population | | | |

TABLE 11A
Growth Data for Listeria in an Untreated Control at 10-hours.

| | Positive/ | | Positive/ |
|---|---|---|---|
| Viability control | Negative | Sterility Control | Negative |
| 1 | + | 1 | − |
| 2 | + | 2 | − |
| Sample | CFU | Log Reduction | % Reduction |
| Control-T-10 | 2.67 × 10⁶ | −1.22 | 1682.61% |
| Population | | | |
| Control-initial | 1.50 × 10⁵ | | |
| population | | | |

TABLE 12A
Growth Data for Listeria in an Untreated Control at 24-hours.

| | Positive/ | | Positive/ |
|---|---|---|---|
| Viability control | Negative | Sterility Control | Negative |
| 1 | + | 1 | − |
| 2 | + | 2 | − |
| Sample | CFU | Log Reduction | % Reduction |
| Control-T-24 | >3.00 × 10⁷ | −2.30 | −19944.59% |
| Population | | | |
| Control-initial | 1.50 × 10⁵ | | |
| population | | | |

TABLE 13A
Growth Data for E. coli 0157:H7
in an Untreated Control at 4-hours.

| | Positive/ | | Positive/ |
|---|---|---|---|
| Viability control | Negative | Sterility Control | Negative |
| 1 | + | 1 | − |
| 2 | + | 2 | − |
| Sample | CFU | Log Reduction | % Reduction |
| Control-T-4 | 1.53 × 10⁵ | −0.26 | −81.86% |
| Population | | | |
| Control-initial | 8.42 × 10⁴ | | |
| population | | | |

TABLE 14A
Growth Data for E. coli 0157:H7 in
an Untreated Control at 10-hours.

| | Positive/ | | Positive/ |
|---|---|---|---|
| Viability control | Negative | Sterility Control | Negative |
| 1 | + | 1 | − |
| 2 | + | 2 | − |
| Sample | CFU | Log Reduction | % Reduction |
| Control-T-10 | 1.61 × 10⁶ | −1.18 | −1856.46% |
| Population | | | |
| Control-initial | 8.42 × 10⁴ | | |
| population | | | |

TABLE 15A
Growth Data for E. coli 0157:H7 in
an Untreated Control at 24-hours.

| | Positive/ | | Positive/ |
|---|---|---|---|
| Viability control | Negative | Sterility Control | Negative |
| 1 | + | 1 | − |
| 2 | + | 2 | − |
| Sample | CFU | Log Reduction | % Reduction |
| Control-T-24 | >3.00 × 10⁷ | −2.55 | −35652.37% |
| Population | | | |
| Control-initial | 8.42 × 10⁴ | | |
| population | | | |

TABLE 16A
Growth Data for Salmonella in an Untreated Control at 4-hours.

| | Positive/ | | Positive/ |
|---|---|---|---|
| Viability control | Negative | Sterility Control | Negative |
| 1 | + | 1 | − |
| 2 | + | 2 | − |
| Sample | CFU | Log Reduction | % Reduction |
| Control-T-4 | 3.65 × 10⁵ | −1.06 | −1356.12% |
| Population | | | |
| Control-initial | 2.77 × 10⁴ | | |
| population | | | |

TABLE 17A
Growth Data for Salmonella in an Untreated Control at 10-hours.

| | | Sterility | |
|---|---|---|---|
| Viability control | Positive/Negative | Control | Positive/Negative |
| 1 | + | 1 | − |
| 2 | + | 2 | − |

| Sample | CFU | Log Reduction | % Reduction |
|---|---|---|---|
| Control-T-10 | 1.37 × 10⁶ | −1.70 | −5065.94% |
| Population | | | |
| Control-initial | 2.77 × 10⁴ | | |
| population | | | |

TABLE 18A
Growth Data for Salmonella in an Untreated Control at 24-hours.

| | | Sterility | |
|---|---|---|---|
| Viability control | Positive/Negative | Control | Positive/Negative |
| 1 | + | 1 | − |
| 2 | + | 2 | − |

| Sample | CFU | Log Reduction | % Reduction |
|---|---|---|---|
| Control-T-24 | >3.00 × 10⁷ | −3.04 | −111840.95% |
| Population | | | |
| Control-initial | 2.77 × 10⁴ | | |
| population | | | |

In comparison to the antimicrobial activity of GPI AMX3, a composition (coded GPI AMX5) comprising pH 6.0 buffered vinegar and an oregano extract (90% and 10% by weight respectively) was tested. As shown in the tables, percentage kill-rates for antimicrobial solution GPI AMX5 (concentrated at 2.5%) from GumProducts International, were determined for Listeria monocytogenes, Escherichia coli O157:H7 and Salmonella enterica after 4-hour, 10-hour and 24-hour treatments. Tables 1B through 3B, show that the antimicrobial solution killed −66.16%, −58.59% and −80.81% of L. monocytogenes at 4-hour, 10-hour and 24-hour treatments, respectively. Tables 4B through 6B, show that the antimicrobial solution killed 74.21%, 81.32% and 91.39% of E. coli O157:H7 at 4-hour, 10-hour and 24-hour treatments, respectively. Tables 7B through 9B, show that the antimicrobial solution killed −72.77%, 7.14% and −23.66% of S. enterica at 4-hour, 10-hour and 24-hour treatments, respectively.

TABLE 1B
Efficacy of GPI AMX5 solution against Listeria monocytogenes
at 4-hours.

| | | Sterility | |
|---|---|---|---|
| Viability control | Positive/Negative | Control | Positive/Negative |
| 1 | + | 1 | − |
| 2 | + | 2 | − |

| Sample | CFU | Log Reduction | % Reduction |
|---|---|---|---|
| GPI AMX5 | 8.23 × 10⁹ | −0.22 | −66.16% |
| Control-initial | 4.95 × 10⁹ | | |
| population | | | |

TABLE 2B
Efficacy of GPI AMX5 solution against Listeria monocytogenes
at 10-hours.

| | | Sterility | |
|---|---|---|---|
| Viability control | Positive/Negative | Control | Positive/Negative |
| 1 | + | 1 | − |
| 2 | + | 2 | − |

| Sample | CFU | Log Reduction | % Reduction |
|---|---|---|---|
| GPI AMX5 | 7.85 × 10⁹ | −0.16 | −58.59% |
| Control-initial | 4.95 × 10⁹ | | |
| population | | | |

TABLE 3B
Efficacy of GPI AMX5 solution against Listeria monocytogenes
at 24-hours.

| | | Sterility | |
|---|---|---|---|
| Viability control | Positive/Negative | Control | Positive/Negative |
| 1 | + | 1 | − |
| 2 | + | 2 | − |

| Sample | CFU | Log Reduction | % Reduction |
|---|---|---|---|
| GPI AMX5 | 8.95 × 10⁹ | −0.26 | −80.81% |
| Control-initial | 4.95 × 10⁹ | | |
| population | | | |

TABLE 4B
Efficacy of GPI AMX5 solution against Escherichia coli 0157:H7
at 4-hours.

| | | Sterility | |
|---|---|---|---|
| Viability control | Positive/Negative | Control | Positive/Negative |
| 1 | + | 1 | − |
| 2 | + | 2 | − |

| Sample | CFU | Log Reduction | % Reduction |
|---|---|---|---|
| GPI AMX5 | 4.90 × 10⁵ | 0.59 | 74.21% |
| Control-initial | 1.90 × 10⁶ | | |
| population | | | |

TABLE 5B
Efficacy of GPI AMX5 solution against Escherichia coli 0157:H7
at 10-hours.

| | | Sterility | |
|---|---|---|---|
| Viability control | Positive/Negative | Control | Positive/Negative |
| 1 | + | 1 | − |
| 2 | + | 2 | − |

| Sample | CFU | Log Reduction | % Reduction |
|---|---|---|---|
| GPI AMX5 | 3.55 × 10⁵ | 0.77 | 81.32% |
| Control-initial | 1.90 × 10⁶ | | |
| population | | | |

TABLE 6B
Efficacy of GPI AMX5 solution against Escherichia coli 0157:H7
at 24-hours.

| | | Sterility | |
|---|---|---|---|
| Viability control | Positive/Negative | Control | Positive/Negative |
| 1 | + | 1 | − |
| 2 | + | 2 | − |

| Sample | CFU | Log Reduction | % Reduction |
|---|---|---|---|
| GPI AMX5 | 1.64 × 10⁵ | 1.14 | 91.39% |
| Control-initial | 1.90 × 10⁶ | | |
| population | | | |

TABLE 7B
Efficacy of GPI AMX5 solution against Salmonella enterica
at 4-hours.

| | | Sterility | |
|---|---|---|---|
| Viability control | Positive/Negative | Control | Positive/Negative |
| 1 | + | 1 | − |
| 2 | + | 2 | − |

| Sample | CFU | Log Reduction | % Reduction |
|---|---|---|---|
| GPI AMX5 | 9.68 × 10⁹ | −0.23 | −72.77% |
| Control-initial | 5.60 × 10⁹ | | |
| population | | | |

TABLE 8B
Efficacy of GPI AMX5 solution against Salmonella enterica
at 10-hours.

| | | Sterility | |
|---|---|---|---|
| Viability control | Positive/Negative | Control | Positive/Negative |
| 1 | + | 1 | − |
| 2 | + | 2 | − |

| Sample | CFU | Log Reduction | % Reduction |
|---|---|---|---|
| GPI AMX5 | 5.20 × 10⁹ | −0.03 | 7.14% |
| Control-initial | 5.60 × 10⁹ | | |
| population | | | |

TABLE 9B
Efficacy of GPI AMX5 solution against Salmonella enterica
at 24-hours.

| | | Sterility | |
|---|---|---|---|
| Viability control | Positive/Negative | Control | Positive/Negative |
| 1 | + | 1 | − |
| 2 | + | 2 | − |

| Sample | CFU | Log Reduction | % Reduction |
|---|---|---|---|
| GPI AMX5 | 6.93 × 10⁹ | −0.09 | −23.66% |
| Control-initial | 5.60 × 10⁹ | | |
| population | | | |

TABLE 10B
Growth Data for Listeria in an Untreated Control at 4-hours.

| | | Sterility | |
|---|---|---|---|
| Viability control | Positive/Negative | Control | Positive/Negative |
| 1 | + | 1 | − |
| 2 | + | 2 | − |

| Sample | CFU | Log Reduction | % Reduction |
|---|---|---|---|
| Control-T-4 Population | 9.00 × 10⁹ | −0.260 | −81.82% |
| Control-initial | 4.95 × 10⁹ | | |
| population | | | |

TABLE 11B
Growth Data for Listeria in an Untreated Control at 10-hours.

| | | Sterility | |
|---|---|---|---|
| Viability control | Positive/Negative | Control | Positive/Negative |
| 1 | + | 1 | − |
| 2 | + | 2 | − |

| Sample | CFU | Log Reduction | % Reduction |
|---|---|---|---|
| Control-T-10 | 1.54 × 10¹⁰ | −0.493 | −211.11% |
| Population | | | |
| Control-initial | 4.95 × 10⁹ | | |
| population | | | |

TABLE 12B
Growth Data for Listeria in an Untreated Control at 24-hours.

| | | Sterility | |
|---|---|---|---|
| Viability control | Positive/Negative | Control | Positive/Negative |
| 1 | + | 1 | − |
| 2 | + | 2 | − |

| Sample | CFU | Log Reduction | % Reduction |
|---|---|---|---|
| Control-T-24 | 2.40 × 10⁹ | 0.314 | 51.52% |
| Population | | | |
| Control-initial | 4.95 × 10⁹ | | |
| population | | | |

TABLE 13B
Growth Data for E. coli 0157:H7 in an Untreated Control at 4-hours.

| | | Sterility | |
|---|---|---|---|
| Viability control | Positive/Negative | Control | Positive/Negative |
| 1 | + | 1 | − |
| 2 | + | 2 | − |

| Sample | CFU | Log Reduction | % Reduction |
|---|---|---|---|
| Control-T-4 Population | 2.95 × 10⁶ | −0.191 | −55.26% |
| Control-initial | 1.90 × 10⁶ | | |
| population | | | |

TABLE 14B
Growth Data for E. coli 0157:H7 in
an Untreated Control at 10-hours.

| | Positive/ | | Positive/ |
|---|---|---|---|
| Viability control | Negative | Sterility Control | Negative |
| 1 | + | 1 | − |
| 2 | + | 2 | − |
| Sample | CFU | Log Reduction | % Reduction |
| Control-T-10 | 3.95 × 10⁶ | −0.318 | −107.89% |
| Population | | | |
| Control-initial | 1.90 × 10⁶ | | |
| population | | | |

TABLE 15B
Growth Data for E. coli 0157:H7 in
an Untreated Control at 24-hours.

| | Positive/ | | Positive/ |
|---|---|---|---|
| Viability control | Negative | Sterility Control | Negative |
| 1 | + | 1 | − |
| 2 | + | 2 | − |
| Sample | CFU | Log Reduction | % Reduction |
| Control-T-24 | 4.20 × 10⁷ | −1.344 | −2110.53% |
| Population | | | |
| Control-initial | 1.90 × 10⁶ | | |
| population | | | |

TABLE 16B
Growth Data for Salmonella in an Untreated Control at 4-hours.

| | Positive/ | | Positive/ |
|---|---|---|---|
| Viability control | Negative | Sterility Control | Negative |
| 1 | + | 1 | − |
| 2 | + | 2 | − |
| Sample | CFU | Log Reduction | % Reduction |
| Control-T-4 | 5.50 × 10⁹ | 0.008 | 1.79% |
| Population | | | |
| Control-initial | 5.60 × 10⁹ | | |
| population | | | |

TABLE 17B
Growth Data for Salmonella in an Untreated Control at 10-hours.

| | Positive/ | | Positive/ |
|---|---|---|---|
| Viability control | Negative | Sterility Control | Negative |
| 1 | + | 1 | − |
| 2 | + | 2 | − |
| Sample | CFU | Log Reduction | % Reduction |
| Control-T-10 | 5.65 × 10⁹ | −0.004 | −0.89% |
| Population | | | |
| Control-initial | 5.60 × 10⁹ | | |
| population | | | |

TABLE 18B
Growth Data for Salmonella in an Untreated Control at 24-hours.

| | Positive/ | | Positive/ |
|---|---|---|---|
| Viability control | Negative | Sterility Control | Negative |
| 1 | + | 1 | − |
| 2 | + | 2 | − |
| Sample | CFU | Log Reduction | % Reduction |
| Control-T-24 | 1.00 × 10¹⁰ | −0.252 | −78.57% |
| Population | | | |
| Control-initial | 5.60 × 10⁹ | | |
| population | | | |

The above experiments suggest that GPI AMX3 of the present invention was more effective at killing Listeria monocytogenes, Escherichia coli 0157:H7 and Salmonella enterica after 4-hour, 10-hour and 24-hour treatments, whereas GPI AM5 was comparably less effective. Buffered vinegar with a pH of between about 4.9-5.7 in combination with rosemary extract and garlic extract is critical for the antimicrobial activities, whereas vinegar with a pH of 6.0 in combination with an oregano extract is not as effective.

### Example 2

Example 2 demonstrates the impact of the present invention on shelf life of food products by inhibiting or suppressing bacterial growth over an extended period of time. Artificially inoculated ‘Ham’ products were each formulated by one of 5 different treatments and were challenged with enteric pathogens. The growth potential of Listeria monocytogenes, E. coli, or Salmonella spp in treated products were determined.

The compositions of the 5 treatments tested are as follows:

Treatment 1: control;

Treatment 2: 96% buffered vinegar 2% rosemary extract, and 2% garlic extract;

Treatment 3: 95% buffered vinegar, 2.5% orange powder, 2.5% lemon powder;

Treatment 4: 99% buffered vinegar, 0.5% rosemary extract, 0.5% garlic extract; and

Treatment 5: buffered vinegar only.

Materials And Methods

The product/treatment(s) challenged by E. coli, Salmonella spp., and L.monocytogenes are described in Table 19. A septum (GE, Silicone II, 100% Silicone, clear transparent, Huntersville, N.C.) was first installed on each product pack by overlaying a bead of silicone over the protective film and allowed to dry while the samples were stored at 4° C.

TABLE 19
Product(s)

| | Treatment | |
|---|---|---|
| Product Description | Formulation | Mean Sample Weight |
| HAM sliced, Treatment 1, | Treatment 1 | 200 g |
| (MAP) | | |
| HAM sliced Treatment 2, | Treatment 2 | 200 g |
| (MAP) | | |
| HAM sliced Treatment 3, | Treatment 3 | 200 g |
| (MAP) | | |
| HAM sliced Treatment 4, | Treatment 4 | 200 g |
| (MAP) | | |
| HAM slicedTreatment 5, | Treatment 5 | 200 g |
| (MAP) | | |

MAP—Modified Atmosphere Packaging (Gas Mixture - not provided/unknown)

Prior to inoculation, bacterial strains (Table 20), were each cultured separately for 18-24 h in BHI broth, mixed thoroughly, and standardized to a 108 CFU/ml density as determined by turbidimetry and standard plate count methods. Cold adaptation of the inoculum was then performed by storage at 4° C. for 7 days (Uyttendaele et al. 2004). For each Treatment, each challenge organism was diluted to 104 CFU/ml in 0.1% peptone water, from which a 1 mL volume was injected into sample packs through the silicone septum using a sterile 1 mL graduated syringe and massaged thoroughly to distribute within the product pack. This resulted in a final inoculation of 104 CFU per product pack or 102 CFU per gram of product. The inoculated samples were then stored at 4° C. for up to 88 days. E. coli ATCC 35218 (Quality control strain) was used as a surrogate for E. coli O157:H7 as per Gurtler et al. (2010) and Pittman et al. (2012).

TABLE 20
Bacterial Strains

| Bacterial strains* | Source | Serotype/Antigen |
|---|---|---|
| Escherichia coli | Canine, Tennessee, USA | — |
| ATCC 35218 | | |
| Salmonella Vellore | Rectal Swab, Emerging | Antigen |
| ATCC 15611 | infectious disease | 1, 4, 12, 27:z10:z35 |
| | research | |
| Listeria monocytogenes | Human, Enteric research | Serotype 4b |
| ATCC 19115 | | |

*Laboratory Services Division Culture Collection.

At each analysis time point, the entire content of three previously inoculated product packs were each aseptically transferred to a 3.5 L sterile stomacher bag and homogenized in a 1:5 ratio with 0.1% peptone water. Ten-fold serial dilutions prepared in 0.1% peptone water were then prepared from the homogenate corresponding to each sample pack, and three 0.33 ml from each of these dilutions were each spread plated onto ALOA Chromogenic Agar and Oxford Agar in accordance with the method MFLP-74, Compendium of Analytical Methods, Government of Canada. The plates were then incubated at 35° C. and examined after 24 and 48 hours of incubation for typical L.monocytogenes colonies.

The enumeration of E. coli was performed using a TEMPO® System (BioMerieux), using TEMPO® EC (Escherichia coli) as described in laboratory method MID-248, Laboratory Services Division. The TEMPO® system associates two single-use disposables which are specific to the microorganism to be detected: a vial containing dehydrated culture medium and an enumeration card with 48 wells of 3 different volumes. The medium, adapted to ensure a rapid detection of E. coli, is inoculated with a dilution of food sample and homogeneously transferred by the TEMPO® Filler into the card. After filing, the Filler seals the card in order to avoid contamination during handling. During incubation the microorganisms present in the card hydrolyze the substrate in the culture medium and cause a fluorescent signal to appear, which is detected by TEMPO® Reader. Depending on the number and size of the positive wells, the system calculates the number of E. coli present in the sample. At each analysis time point, the entire content of three previously inoculated product packs were each aseptically transferred to a sterile stomacher bag and homogenized in a 1:10 dilution using 0.1% peptone water and analyzed by the TEMPO® system.

To enumerate Salmonella spp. at each analysis time point, the entire content of three previously inoculated product packs were each aseptically transferred to a 3.5 L sterile stomacher bag and homogenized in a 1:5 ratio 0.1% peptone buffer. Ten-fold serial dilutions prepared in 0.1% peptone water were then prepared from the homogenate corresponding to each sample pack, and three 0.33 ml from each of these dilutions were each spread plated onto BGS and BIS Agars. The plates were then incubated at 35° C. and examined after 24 and 48 hours of incubation for typical salmonella colonies.

In this study, the growth potential (δ) is defined as the difference between the log 10 concentration at the end of the challenge test and the log 10 concentration at the beginning of the challenge test at day 0. The difference between the median of the log 10 concentration at the end day of the challenge test and the median of the log 10 concentration at Day 0 was calculated. Note that the median is the intermediate result among at least two of three analyses. If one of three results was undefined or unsuitable, the median was then the lower of the two other results. Once each batch had been inoculated and enumerated at each analysis time point, the standard deviation between the 3 log-results (or between the 2 log-results if one of them unsuitable) was calculated. If the standard deviation (due to measurement uncertainty and contamination heterogeneity) equaled or was higher than 0.30 log CFU/g or per mL, then the data for this given time point was deemed to be not acceptable. The growth potential (δ) can be interpreted as follows:
If (δ)>0.5 log₁₀ concentration, the product/treatment is able to support the growth of the challenge organism.
If (δ)<0.5 log₁₀ concentration, the food product is unable to support the growth of the challenge organism.

The pH of representative un-inoculated product samples was measured at Day 0, 35 and 88 of the test period in accordance with the method MFHPB-03, Compendium of Analytical Methods, Government of Canada.

The water activity (aw) of un-inoculated product samples was measured at Day 0, 35 and 88 of the test period in accordance with the laboratory procedure MFLP-66, Compendium of Analytical Methods, Government of Canada.

The enumeration of E. coli was performed using a TEMPO® System (BioMerieux), using TEMPO® LAB (Lactic Acid bacteria) as described in laboratory method MID-248, Laboratory Services Division. The enumeration of Total Viable counts was also performed using a TEMPO® System (BioMerieux), using TEMPO® TVC (Total Viable Counts) as described in laboratory method MID-248 Laboratory Services Division as per MFLP-17 Compendium of Analytical Methods, Government of Canada. At each analysis time point, the entire content of three previously inoculated product packs were each aseptically transferred to a sterile stomacher bag and homogenized in a 1:10 dilution using 0.1% peptone water and analyzed by the TEMPO® system.

An increase in 1 log 10 CFU/g over two or more time intervals is generally considered significant by food microbiologists (Vestergard, 2001). Smaller increases may be significant depending upon the enumeration methods, number of samples and replicates used, and the variability among data points. Thus, in determining that a product does not support growth of a pathogen, in general less than a 1-log increase above the initial inoculum level throughout the intended shelf life of the product and across replicate trials would be an appropriate acceptance criterion. This level reflects the inherent variation that exists with enumeration of microorganisms.

As shown in Table 21, Treatment 2 of the present invention was the most effective at inhibiting the growth of Salmonella spp with an estimated decrease in counts of 1.29 log 10 CFU/g (Treatment 2) by day 88. Treatment 2 and 4 of the present invention were also the most effect at inhibiting the growth of E. coli which decreased to non-detectable levels by day 88. Further, Treatment 2 and 4 exhibited significantly stronger inhibition against the growth of L.monocytogenes, in sharp contrast to the control.

TABLE 21
Growth Potential of Enteric Pathogens During after 88 day storage period at 4° C.

| | E. coli | Salmonella spp | L. monocytogenes |
|---|---|---|---|
| Treatment | Growth Potential (δ) | Growth Potential (δ) | Growth Potential (δ) |
| Treatment 1 | −1.28 Log₁₀ CFU/g | −0.41 Log₁₀ CFU/g | +2.05 Log₁₀ CFU/g |
| | | | (Day 74) |
| Treatment 2 | ≧−1.18 Log₁₀ CFU/g | −1.29 Log₁₀ CFU/g | −0.17 Log₁₀ CFU/g |
| | Non-Detectable | | |
| Treatment 3 | −0.84 Log₁₀ CFU/g | −0.69 Log₁₀ CFU/g | −0.28 Log₁₀ CFU/g |
| Treatment 4 | ≧−1.48 Log₁₀ CFU/g | −0.54 Log₁₀ CFU/g | +0.35 Log₁₀ CFU/g |
| | Non-Detectable | | |
| Treatment 5 | −1.16 Log₁₀ CFU/g | −0.53 Log₁₀ CFU/g | −0.14 Log₁₀ CFU/g |

Significant decrease of >1 Log₁₀ CFU/g (♦); Significant growth of >1 Log₁₀ CFU/g (♦); Decrease of >0.5 to <1 Log₁₀ CFU/g (♦); Marginal decrease of <0.5 Log₁₀ CFU/g (♦); Growth of <0.5 Log₁₀ CFU/g (♦).

TABLE 22
Growth potential of E. coli in Ham product Treatment 1 stored at 4° C. for 88 days.

| | | | | | Growth |
|---|---|---|---|---|---|
| | | E. coli | Log₁₀ | Mean Log₁₀ | Potential (δ) |
| Test | | count | (CFU/g) | (CFU/g) ± | Log₁₀ |
| Day | Sample ID | (CFU/g) | In bold: Median | Standard Deviation | (CFU/sample) |
| 0 | 13-047001-0043 | 1.50E+02 | 2.18 | 2.49 ± 0.27 | δ₈₈ = −1.28 |
| 0 | 13-047001-0044 | 4.50E+02 | 2.65 | | |
| 0 | 13-047001-0045 | 4.40E+02 | 2.64 | | |
| 35 | 13-047001-0046 | 5.60E+01 | 1.75 | 1.75 | |
| 35 | 13-047001-0047 | <10 | <1.0 | | |
| 35 | 13-047001-0048 | <10 | <1.0 | | |
| 42 | 13-047001-0049 | 5.60E+01 | 1.75 | 2.67 ± 0.07 | |
| 42 | 13-047001-0050 | 4.10E+01 | 1.61 | | |
| 42 | 13-047001-0051 | 4.60E+01 | 1.66 | | |
| 49 | 13-047001-0052 | <10 | <1.0 | 1.60 ± 0.17 | |
| 49 | 13-047001-0053 | 3.00E+01 | 1.48 | | |
| 49 | 13-047001-0054 | 5.30E+01 | 1.72 | | |
| 60 | 13-047001-0055 | 7.70E+01 | 1.89 | 1.96 ± 0.16 | |
| 60 | 13-047001-0056 | 7.10E+01 | 1.85 | | |
| 60 | 13-047001-0057 | 1.40E+02 | 2.15 | | |
| 74 | 13-047001-0058 | 9.30E+01 | 1.97 | 1.52 ± 0.63 | |
| 74 | 13-047001-0059 | <10 | NA | (UNS) | |
| 74 | 13-047001-0060 | 1.20E+01 | 1.08 | | |
| 88 | 13-047001-0061 | 2.30E+01 | 1.36 | 1.44 ± 0.11 | |
| 88 | 13-047001-0062 | 3.30E+01 | 1.52 | | |
| 88 | 13-047001-0063 | <10 | <1.0 | | |

UNS—Unsuitable

TABLE 22
Growth potential of E. coli in Ham product Treatment 2 stored at 4° C. for 88 days.

| | | | | | Growth |
|---|---|---|---|---|---|
| | | E. coli | Log₁₀ | Mean Log₁₀ | Potential (δ) |
| Test | | count | (CFU/g) | (CFU/g) ± | Log₁₀ |
| Day | Sample ID | (CFU/) | In bold: Median | Standard Deviation | (CFU/sample) |
| 0 | 13-047055-0043 | 1.50E+02 | 2.18 | 2.20 ± 0.25 | δ₇₄ = −0.95 |
| 0 | 13-047055-0044 | 2.90E+02 | 2.46 | | δ₈₈ ≧ −1.18 |
| 0 | 13-047055-0045 | 9.30E+01 | 1.97 | | |
| 35 | 13-047055-0046 | 1.80E+01 | 1.26 | 1.56 ± 0.37 | |
| 35 | 13-047055-0047 | 2.80E+01 | 1.45 | (UNS) | |
| 35 | 13-047055-0048 | 9.30E+01 | 1.97 | | |
| 42 | 13-047055-0049 | 1.00E+01 | 1.00 | 1.46 ± 0.41 | |
| 42 | 13-047055-0050 | 3.80E+01 | 1.58 | (UNS) | |
| 42 | 13-047055-0051 | 6.30E+01 | 1.80 | | |
| 49 | 13-047055-0052 | 5.70E+01 | 1.76 | 1.66 ± 0.18 | |
| 49 | 13-047055-0053 | 5.80E+01 | 1.76 | | |
| 49 | 13-047055-0054 | 2.80E+01 | 1.45 | | |
| 60 | 13-047055-0055 | 1.00E+02 | 2.00 | 1.56 ± 0.63 | |
| 60 | 13-047055-0056 | <10 | <1.0 | (UNS) | |
| 60 | 13-047055-0057 | 1.30E+01 | 1.11 | | |
| 74 | 13-047055-0058 | <10 | <1.0 | 1.41 ± 0.25 | |
| 74 | 13-047055-0059 | 1.70E+01 | 1.23 | | |
| 74 | 13-047055-0060 | 3.90E+01 | 1.59 | | |
| 88 | 13-047055-0061 | <10 | <1.0 | <1.0 | |
| 88 | 13-047055-0062 | <10 | <1.0 | | |
| 88 | 13-047055-0063 | <10 | <1.0 | | |

UNS—Unsuitable

TABLE 23
Growth potential of E. coli in Ham product Treatment 2 stored at 4° C. for 88 days.

| | | | | | Growth |
|---|---|---|---|---|---|
| | | E. coli | Log₁₀ | Mean Log₁₀ | Potential (δ) |
| Test | | count | (CFU/g) | (CFU/g) ± | Log₁₀ |
| Day | Sample ID | (CFU/) | In bold: Median | Standard Deviation | (CFU/sample) |
| 0 | 13-047055-0043 | 1.50E+02 | 2.18 | 2.20 ± 0.25 | δ₇₄ = −0.95 |
| 0 | 13-047055-0044 | 2.90E+02 | 2.46 | | δ₈₈ ≧ −1.18 |
| 0 | 13-047055-0045 | 9.30E+01 | 1.97 | | |
| 35 | 13-047055-0046 | 1.80E+01 | 1.26 | 1.56 ± 0.37 | |
| 35 | 13-047055-0047 | 2.80E+01 | 1.45 | (UNS) | |
| 35 | 13-047055-0048 | 9.30E+01 | 1.97 | | |
| 42 | 13-047055-0049 | 1.00E+01 | 1.00 | 1.46 ± 0.41 | |
| 42 | 13-047055-0050 | 3.80E+01 | 1.58 | (UNS) | |
| 42 | 13-047055-0051 | 6.30E+01 | 1.80 | | |
| 49 | 13-047055-0052 | 5.70E+01 | 1.76 | 1.66 ± 0.18 | |
| 49 | 13-047055-0053 | 5.80E+01 | 1.76 | | |
| 49 | 13-047055-0054 | 2.80E+01 | 1.45 | | |
| 60 | 13-047055-0055 | 1.00E+02 | 2.00 | 1.56 ± 0.63 | |
| 60 | 13-047055-0056 | <10 | <1.0 | (UNS) | |
| 60 | 13-047055-0057 | 1.30E+01 | 1.11 | | |
| 74 | 13-047055-0058 | <10 | <1.0 | 1.41 ± 0.25 | |
| 74 | 13-047055-0059 | 1.70E+01 | 1.23 | | |
| 74 | 13-047055-0060 | 3.90E+01 | 1.59 | | |
| 88 | 13-047055-0061 | <10 | <1.0 | <1.0 | |
| 88 | 13-047055-0062 | <10 | <1.0 | | |
| 88 | 13-047055-0063 | <10 | <1.0 | | |

UNS—Unsuitable

TABLE 24
Growth potential of Salmonella spp. in Ham product
Treatment 1 stored at 4° C. for 88 days.

| | | | | | Growth |
|---|---|---|---|---|---|
| | | Salmonella | Log₁₀ | Mean Log₁₀ | Potential (δ) |
| Test | | spp. count | (CFU/g) | (CFU/g) ± | Log₁₀ |
| Day | Sample ID | (CFU/g) | In bold: Median | Standard Deviation | (CFU/sample) |
| 0 | 13-047001-0022 | 2.53E+02 | 2.40 | 2.45 ± 0.07 | δ₈₈ = −0.41 |
| 0 | 13-047001-0023 | 3.40E+02 | 2.53 | | |
| 0 | 13-047001-0024 | 2.68E+02 | 2.43 | | |
| 35 | 13-047001-0025 | 1.98E+02 | 2.30 | 2.32 ± 0.02 | |
| 35 | 13-047001-0026 | 2.18E+02 | 2.34 | | |
| 35 | 13-047001-0027 | 2.13E+02 | 2.33 | | |
| 42 | 13-047001-0028 | 1.30E+02 | 2.11 | 2.26 ± 0.13 | |
| 42 | 13-047001-0029 | 2.00E+02 | 2.30 | | |
| 42 | 13-047001-0030 | 2.35E+02 | 2.37 | | |
| 49 | 13-047001-0031 | 2.05E+02 | 2.31 | 2.35 ± 0.04 | |
| 49 | 13-047001-0032 | 2.15E+02 | 2.33 | | |
| 49 | 13-047001-0033 | 2.50E+02 | 2.40 | | |
| 60 | 13-047001-0034 | 2.10E+02 | 2.32 | 2.27 ± 0.04 | |
| 60 | 13-047001-0035 | 1.80E+02 | 2.26 | | |
| 60 | 13-047001-0036 | 1.75E+02 | 2.24 | | |
| 74 | 13-047001-0037 | 9.25E+01 | 1.97 | 2.06 ± 0.12 | |
| 74 | 13-047001-0038 | 1.08E+02 | 2.03 | | |
| 74 | 13-047001-0039 | 1.58E+02 | 2.20 | | |
| 88 | 13-047001-0040 | 7.75E+01 | 1.89 | 2.01 ± 0.12 | |
| 88 | 13-047001-0041 | 1.05E+02 | 2.02 | | |
| 88 | 13-047001-0042 | 1.35E+02 | 2.13 | | |

TABLE 25
Growth potential of Salmonella spp. in Ham product
Treatment 2 stored at 4° C. for 88 days.

| | | | | | Growth |
|---|---|---|---|---|---|
| | | Salmonella | Log₁₀ | Mean Log₁₀ | Potential (δ) |
| Test | | spp. count | (CFU/g) | (CFU/g) ± | Log₁₀ |
| Day | Sample ID | (CFU/g) | In bold: Median | Standard Deviation | (CFU/sample) |
| 0 | 13-047055-0022 | 4.10E+02 | 2.61 | 2.54 ± 0.07 | δ₇₄ = −0.47 |
| 0 | 13-047055-0023 | 2.93E+02 | 2.47 | | δ₈₈ = −1.29 |
| 0 | 13-047055-0024 | 3.40E+02 | 2.53 | | |
| 35 | 13-047055-0025 | 1.25E+02 | 2.10 | 2.12 ± 0.14 | |
| 35 | 13-047055-0026 | 9.80E+01 | 1.99 | | |
| 35 | 13-047055-0027 | 1.83E+02 | 2.26 | | |
| 42 | 13-047055-0028 | 2.25E+02 | 2.35 | 2.28 ± 0.09 | |
| 42 | 13-047055-0029 | 1.50E+02 | 2.18 | | |
| 42 | 13-047055-0030 | 2.10E+02 | 2.32 | | |
| 49 | 13-047055-0031 | 9.50E+01 | 1.98 | 2.19 ± 0.18 | |
| 49 | 13-047055-0032 | 1.85E+02 | 2.27 | | |
| 49 | 13-047055-0033 | 2.05E+02 | 2.31 | | |
| 60 | 13-047055-0034 | 8.00E+01 | 1.90 | 2.11 ± 0.18 | |
| 60 | 13-047055-0035 | 1.65E+02 | 2.22 | | |
| 60 | 13-047055-0036 | 1.65E+02 | 2.22 | | |
| 74 | 13-047055-0037 | 1.15E+02 | 2.06 | 2.05 ± 0.19 | |
| 74 | 13-047055-0038 | 1.70E+02 | 2.23 | | |
| 74 | 13-047055-0039 | 7.25E+01 | 1.86 | | |
| 88 | 13-047055-0040 | 1.75E+01 | 1.24 | 1.14 ± 0.70 | |
| 88 | 13-047055-0041 | 2.50E+00 | 0.40 | (UNS) | |
| 88 | 13-047055-0042 | 6.00E+01 | 1.78 | | |

UNS—Unsuitable

TABLE 26
Growth potential of Listeria monocytogenes in Ham
product Treatmet 1 stored at 4° C. for 88 days.

| | | Listeria | | | Growth |
|---|---|---|---|---|---|
| | | monocytogenes | Log₁₀ | Mean Log₁₀ | Potential (δ) |
| Test | | count | (CFU/g) | (CFU/g) ± | Log₁₀ |
| Day | Sample ID | (CFU/g) | In bold: Median | Standard Deviation | (CFU/sample) |
| 0 | 13-047001-0001 | 6.70E+02 | 2.83 | 2.79 ± 0.11 | δ₇₄ > 2.05 |
| 0 | 13-047001-0002 | 7.40E+02 | 2.87 | | δ₈₈ > 2.57 |
| 0 | 13-047001-0003 | 4.66E+02 | 2.67 | | |
| 35 | 13-047001-0004 | 4.30E+02 | 2.63 | 2.62 ± 0.03 | |
| 35 | 13-047001-0005 | 4.50E+02 | 2.65 | | |
| 35 | 13-047001-0006 | 3.86E+02 | 2.59 | | |
| 42 | 13-047001-0007 | 2.06E+02 | 2.31 | 2.50 ± 0.16 | |
| 42 | 13-047001-0008 | 3.80E+02 | 2.58 | | |
| 42 | 13-047001-0009 | 4.03E+02 | 2.61 | | |
| 49 | 13-047001-0010 | 5.23E+02 | 2.72 | 2.65 ± 0.09 | |
| 49 | 13-047001-0011 | 4.90E+02 | 2.69 | | |
| 49 | 13-047001-0012 | 3.56E+02 | 2.55 | | |
| 60 | 13-047001-0013 | 1.56E+03 | 3.19 | 2.37 ± 0.15 | |
| 60 | 13-047001-0014 | 2.74E+03 | 3.44 | | |
| 60 | 13-047001-0015 | 2.99E+03 | 3.48 | | |
| 74 | 13-047001-0016 | 4.83E+04 | 4.68 | 4.86 ± 0.16 | |
| 74 | 13-047001-0017 | 7.50E+04 | 4.88 | | |
| 74 | 13-047001-0018 | 1.02E+05 | 5.01 | | |
| 88 | 13-047001-0019 | >2.50E+05 | >5.40 | >5.40 | |
| 88 | 13-047001-0020 | >2.50E+05 | >5.40 | | |
| 88 | 13-047001-0021 | >2.50E+05 | >5.40 | | |

TABLE 27
Growth potential of Listeria monocytogenes in Ham
product Treatment 2 stored at 4° C. for 88 days.

| | | Listeria | | | Growth |
|---|---|---|---|---|---|
| | | monocytogenes | Log₁₀ | Mean Log₁₀ | Potential (δ) |
| Test | | count | (CFU/g) | (CFU/g) ± | Log₁₀ |
| Day | Sample ID | (CFU/g) | In bold: Median | Standard Deviation | (CFU/sample) |
| 0 | 13-047055-0001 | 5.06E+02 | 2.70 | 2.68 ± 0.02 | δ₈₈ = −0.17 |
| 0 | 13-047055-0002 | 4.66E+02 | 2.67 | | |
| 0 | 13-047055-0003 | 4.66E+02 | 2.67 | | |
| 35 | 13-047055-0004 | 4.57E+02 | 2.66 | 2.56 ± 0.09 | |
| 35 | 13-047055-0005 | 2.97E+02 | 2.47 | | |
| 35 | 13-047055-0006 | 3.63E+02 | 2.56 | | |
| 42 | 13-047055-0007 | 2.73E+02 | 2.44 | 2.50 ± 0.07 | |
| 42 | 13-047055-0008 | 3.03E+02 | 2.48 | | |
| 42 | 13-047055-0009 | 3.76E+02 | 2.58 | | |
| 49 | 13-047055-0010 | 3.86E+02 | 2.59 | 2.59 ± 0.02 | |
| 49 | 13-047055-0011 | 4.10E+02 | 2.61 | | |
| 49 | 13-047055-0012 | 3.83E+02 | 2.58 | | |
| 60 | 13-047055-0013 | 5.30E+02 | 2.72 | 2.65 ± 0.09 | |
| 60 | 13-047055-0014 | 4.60E+02 | 2.66 | | |
| 60 | 13-047055-0015 | 3.56E+02 | 2.55 | | |
| 74 | 13-047055-0016 | 4.83E+02 | 2.68 | 2.60 ± 0.08 | |
| 74 | 13-047055-0017 | 3.36E+02 | 2.53 | | |
| 74 | 13-047055-0018 | 4.00E+02 | 2.60 | | |
| 88 | 13-047055-0019 | 2.00E+02 | 2.30 | 2.46 ± 0.14 | |
| 88 | 13-047055-0020 | 3.13E+02 | 2.50 | | |
| 88 | 13-047055-0021 | 3.73E+02 | 2.57 | | |

Marginal growth of Lactic Acid Bacteria (<100 cfu/g) and low Total Viable Counts (<100 CFU/g) were observed from non-inoculated samples in all 5 treatments. The pH (6.1 to 6.3) and water activity values (0.98) of the samples were deemed suitable for the growth of the challenge organisms and remained constant during the 88 day test period.

Referring now to the drawings, FIG. 1A illustrates the antimicrobial effect of an exemplary composition (GPI AMX3) of the present invention. The growth of all three tested bacteria (Listeria monocytogenes, Escherichia coli (O157:H7), and Salmonella enterica) were inhibited over a 24 hour span.

FIG. 2A illustrates the surviving bacterial population in an untreated-control. Significant growth was observed for all three bacteria (Listeria monocytogenes, Escherichia coli (O157:H7), and Salmonella enterica) in the untreated-control.

FIG. 1B illustrates the effect of an reference composition (GPI AMX5) on the growth of Listeria monocytogenes, Escherichia coli (O157:H7), and Salmonella enterica.

FIG. 2B illustrates the growth of Listeria monocytogenes, Escherichia coli (O157:H7), and Salmonella enterica in an untreated-control in comparison to the result shown in FIG. 1B.

FIG. 3 illustrates an exemplary process flow chart of rosemary extract.

The present invention, therefore, is well adapted to carry out the objects and attain the ends and advantages mentioned, as well as others inherent therein. While the invention has been depicted and described and is defined by reference to particular preferred embodiments of the invention, such references do not imply a limitation on the invention, and no such limitation is to be inferred. The invention is capable of considerable modification, alteration and equivalents in form and function, as will occur to those ordinarily skilled in the pertinent arts. The depicted and described preferred embodiments of the invention are exemplary only and are not exhaustive of the scope of the invention. Consequently, the invention is intended to be limited only by the spirit and scope of the appended claims, giving full cognizance to equivalents in all respects.

1. A composition for treating a food product comprising buffered vinegar, rosemary extract, and garlic extract.

2. The composition of claim 1 wherein the pH of the buffered vinegar is between about 4.9 to 5.7.

3. The composition of claim 1 wherein the amount of the buffered vinegar is between about 80% to 99.8% by weight, the amount of the rosemary extract is between about 0.1% to 10% by weight, and the amount of the garlic extract is between about 0.1% to 10% by weight.

4. The composition of claim 1 wherein the rosemary extract is selected from one or more members from the group consisting of carnosic acid and carnosol.

5. The composition of claim 1 wherein the rosemary extract contains a minimum level of 5% rosmarinic acid and/or the garlic extract contains a minimum level of 1.5% allicin.

6. The composition of claim 1 wherein the buffered vinegar is prepared by adding to a vinegar an effective amount one or more member selected from the group consisting of sodium carbonate, sodium bicarbonate, potassium carbonate, and potassium bicarbonate.

7. A food product treated with composition according to claim 1.

8. The food product of claim 7 where in the food product is a ready-to-eat food product.

9. The food product of claim 7 where in the food product is a ready-to-cook food product.

10. The food product of claim 7 where in the food product is meat or poultry.

11. A method of treating a food product comprising applying to the food product a composition of claim 1.

12. A method of preparing a composition for treating a food product, comprising mixing buffered vinegar, rosemary extract, and garlic extract, wherein the buffered vinegar is between about 80% to 99.8% by weight and has a pH of between 4.9 to 5.7, the rosemary extract is between about 0.1% to 10% by weight, and the garlic extract is between about 0.1% to 10% by weight.

13. The method of claim 12 wherein the buffered vinegar is prepared by adding to vinegar an effective amount one or more members selected from the group consisting of sodium carbonate, sodium bicarbonate, potassium carbonate, potassium bicarbonate.
